(19) United States
(12) Patent Application Publication
(10) Pub. No.: US 2011/0225093 A1
(43) Pub. Date: Sep. 15, 2011

(54) Depository-Based Security Trading System

(76) Inventor: Robert S. Cahn, Carmel, NY (US)

(21) Appl. No.: 13/028,392

(22) Filed: Feb. 16, 2011

Related U.S. Application Data
(60) Provisional application No. 61/312,715, filed on Mar. 11, 2010.

(51) Int. Cl. G06Q 40/00; H04L 9/30

(52) U.S. Cl. 705/75; 705/37

(57) ABSTRACT

A system for protecting individuals (including institutions) involved in securities transactions has been created that utilizes an “independent” depository as an intermediary between a security owner and a brokerage firm. The inclusion of a depository is considered to protect the security owner from untoward actions on the part of the brokerage firm. The depository is used to “hold” the securities behalf of the owner. The security owners and brokerage firms must be registered with the depository and maintain accounts with the depository. All transactions involving the securities are still performed by the broker, but the requests are transmitted from the security owner to the depository, and the depository then relays messages regarding the transactions to the broker. Thus, the securities are only in the possession of the broker on a transaction-by-transaction basis.

### CROSS-REFERENCE TO RELATED APPLICATIONS

This application claims the benefit of U.S. Provisional Application No. 61/312,715, filed Mar. 11, 2010 and herein incorporated by reference.

### TECHNICAL FIELD

The present invention relates to a system for protecting individuals (including institutions) involved in securities transactions and, more particularly, to the utilization of an “independent” depository as an intermediary between a security owner and a brokerage firm to protect the security owner from untoward actions on the part of the brokerage firm.

### BACKGROUND OF THE INVENTION

The prior art is replete with methods for effecting the electronic trading of securities. The following is considered to be merely representative:

U.S. Pat. No. 6,498,282, entitled “System and Method for Conducting Securities Transactions over a Computer Network” issued to W. D. Buist on Jun. 18, 2001. The Buist system and method are associated with trading of securities over the Internet both on national exchanges and outside the national exchanges. The preferred embodiment supports an improved human interface and a continuous display of real-time stock quotes on the user's computer screen. The users are subscribers to a securities trading service that is offered over the Internet. Each subscriber to this service is simultaneously connected from his own computer to a first system that provides user-to-user trading capabilities and to a second system that is a broker/dealer system of his choosing. The broker/dealer system is a server-based system (such as common server systems used by brokers to maintain client accounts). In the Buist system, the broker/dealer server communicates with the user's computer, as well as with the root server of the user-to-user system, where the user-to-user system provides real-time continuously-updated stock information and facilitates user-to-user trades that have been approved by the broker/dealer systems with which it interacts.

The Buist system, however, has a problem that if the broker/dealer fails, there is no protection for the owner of the securities. If the broker/dealer files for bankruptcy, this will wreak havoc with the individual's accounts. It is fear of such bankruptcy that causes large clients of a broker/dealer to withdraw their accounts if there seems to be any chance of failure. Such withdrawals have occurred in the past and have contributed to the collapse of well-respected financial institutions in the recent “financial meltdown” in the United States.

US Patent Publication 2005/0038727, entitled “A System for Securities Exchange Direct Trade and Direct Shorting”, issued to G. Ballman on Feb. 17, 2005 relates to a trading system based upon actions by individuals (“rights holders”) as opposed to brokers. In the Ballman system, the broker is given the ability to trade only as an agent for the individual. In particular, the Ballman system relates to a data processing system and method for managing broker transactions and information in compliance with government regulations. The data processing system further provides for managing other types of broker transaction information such as client profiles, and for providing security measures that enhance the ability to prevent unauthorized trade activities. Some specific functional aspects of the data processing system include the ability to monitor and record any/all data changes made to previously-entered trade records. This audit function prevents the changing of any trade record data without some record being made in the main database. A trade audit report may be generated that shows a change status with regard to each trade record. The Ballman data processing system and method results in a comprehensive means to assist broker/dealer representatives, local brokerage offices and government regulators in dealing not only with SEC, national, international and regional rules, but to better record and track all operations of a brokerage.

The Ballman system depends on the transactions being controlled by a nameless third party. Even in the advanced days of computer-based transactions, individuals may prefer to use the services of a broker (and their expertise), maintaining and building a relationship with a trusted broker. Additionally, as with the Buist system, the Ballman system provides no protections to the individuals. The auditing properties work well in protecting the trading systems from untrustworthy brokers, but do nothing to protect the interests of the individuals.

US Patent Publication 2010/0057608 entitled “System and Methods for Processing Open-End Mutual Fund Purchase and Redemption Orders at Centralized Securities Exchanges and Other Securities Trading and Processing Platforms”, issued to J. McPherson on Mar. 4, 2010 relates to a system for processing traditional open-end mutual fund purchase and redemption orders at a server at designated Exchanges(s) for receiving order messages from a plurality of Brokers and Member Firms, the server having at least one processor and memory for storing routines operable to process individual or aggregated order messages, preferably based on a prioritized set of business rules, and/or match the purchase and redemption orders, reformat the orders, and transmit the reformatted orders to at least one of a plurality of Fund/Securities Clearing Agents, Funds/Transfer Agents and Depositaries for confirmation, and clearing and settlement of issuance and redemption orders for mutual fund shares, as well as payment of mutual fund dividends.

While this McPherson system uses a depository, it is working as a clearinghouse mechanism in a “back office”, processing transactions at the end of the business day and posting entries to the separate accounts.

In most of the current systems involving electronic trading, the securities are held in the name of the brokerage firm (“street name”) instead of the individual owner, where the broker acknowledges to the customer that their shares are on deposit. This system works well until the brokerage firm develops problems—goes out of business, declares bankruptcy, or otherwise can longer perform the trades. Also, as with recent “bad actor” affairs, this enables Ponzi schemes where the broker has used customer securities for his or her benefit—while lying to the clients about the value and content of their holdings.

At this point, two things become apparent. Many accounts do not have insurance protection. Therefore, if a brokerage firm goes out of business, there is no mechanism for determining the actual number of shares of different securities “owned” by the various customers. Exacerbating this problem is that it may take weeks or months to unravel the ownership issues and track down the actual securities owned by a customer. During this period of time, one or more of the securities may decline in value, but the customer cannot effect a trade without having “clear title” to the securities.

### SUMMARY OF THE INVENTION

The need remaining in the art is addressed by the present invention, which relates to a system for protecting individuals (including institutions) involved in securities transactions and, more particularly, to the utilization of an “independent” depository as an intermediary between a security owner and a brokerage firm to protect the security owner from untoward actions on the part of the brokerage firm and enable the settlement of legitimate trades as quickly as if the securities were held in “street name”.

In accordance with the present invention, a depository is utilized as a secure “holder” of the securities instruments on behalf of the security owner. The security owners and brokerage firms must be registered with the depository and maintain accounts with the depository. All transactions involving the securities are still performed by the broker, but the requests are transmitted from the security owner to the depository, and the depository then relays messages regarding the transactions to the broker.

It is an advantage of the arrangement of the present invention that by virtue of the actual securities being held by the depository in the name of the owner, there is no need to perform transactions in “street name”. And, as a result, should the broker go out of business for any reason, there is no concern on the part of the security owner regarding reclaiming his securities—they remain safely within the control and confines of the depository. That is, the customers are protected against broker bankruptcy or failure and still able to trade securities as if they were held in “street name”.

The depository is used to create accounts for both individuals and brokers, transfer securities from the individual to the depository, initiate “sell” transactions with the broker, individual “buy” transactions with the broker, and provide various services associated with margin accounts, loans, etc. The securities are held by the depository and only transferred to the broker as needed (i.e., to complete a sale or secure a loan), on a transaction-by-transaction basis, as requested by the account owner.

These and other features and advantages of the present invention will become apparent during the course of the following discussion and by reference to the accompanying drawings.

### BRIEF DESCRIPTION OF THE DRAWINGS

Referring now to the drawings,

FIG. 1 is a simplified drawing of an exemplary system for utilizing a depository as an intermediary in securities transactions in accordance with the present invention;

FIG. 2 is a flowchart illustrating the steps of establishing an individual user's account with the depository;

FIG. 3 shows an exemplary account owner record as stored at the depository, identifying the assets that the account owner has transferred to the depository for safekeeping, the depository releasing the assets to a broker on an “as needed”, transaction-by-transaction basis;

FIG. 4 is a flowchart of an exemplary process for “selling” a security through the depository in accordance with the present invention;

FIG. 5 shows an exemplary “sell” message as created by the account owner;

FIG. 6 is the encoded form of the “sell” message that is transmitted to the depository with the “private key” signature of the account owner;

FIG. 7 is an updated version of the “sell” message after it has been verified by the depository and re-signed with its private key;

FIG. 8 shows an exemplary “sale” message as created by a broker upon the successful completion of a sale on behalf of the account owner;

FIG. 9 is a flowchart showing the role of the depository in effectuating the actual transfer of assets upon completion of the sale;

FIG. 10 illustrates an exemplary “transfer” message as used by an account owner to authorize the transfer of sold assets to the account of the proper broker;

FIG. 11 is a flowchart describing an exemplary “transfer” process;

FIG. 12 shows an exemplary “buy” message as created by an account owner and used for purchasing securities in the instance where it is preferred to perform the purchase through the depository;

FIG. 13 is a flowchart of an exemplary “buy” process;

FIG. 14 is an exemplary “purchase” message as created by a broker upon the successful purchase of the desired securities on behalf of the account owner;

FIG. 15 illustrates an alternative “buy” message as used by an account owner that wishes to purchase the securities at “market value”;

FIG. 16 is a flowchart of a specific process of determining a cash encumbrance to use with a “market value” purchase;

FIG. 17 shows an exemplary message for establishing a “margin” account with the depository;

FIG. 18 shows an exemplary sequence of transactions between the account owner, depository and broker involved in the establishment of a margin account; and

FIG. 19 is a message used by the account owner to transfer certain assets to his margin account FIG. 20 is a message used by the broker to initiate the process of borrowing securities from a margin account of a first account owner for use by a second account owner;

FIG. 21 is a message used by the account owner to authorize a named “manager” to initiate transactions on his behalf; and

FIG. 22 is a message used by the account owner to cancel the authorization of an account manager.

### DETAILED DESCRIPTION

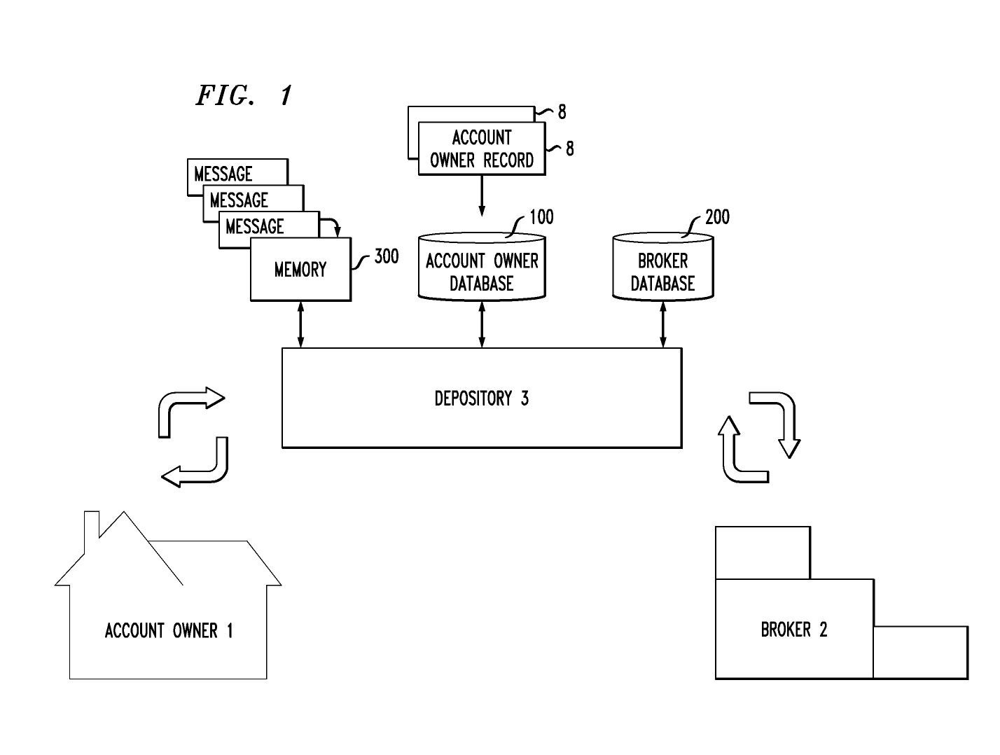

FIG. 1 illustrates an exemplary system for providing trading, in accordance with the present invention, on behalf of an individual security owner 1 (hereinafter referred to as an “account owner”). In the past, an account owner would directly interact with his broker/brokerage firm 2 in buying and selling securities. While some of the transactions could be discussed “in person” and may even involve the actual sale of paper stock certificates, most of today's transactions occur online, with secure communications between account owner 1 and broker 2 used to perform the transaction. While providing for ease of transaction, the electronic exchange of securities and funds has created a situation where if the broker goes out of business or fails for a variety of reasons, the account owner may not be able to readily recover the securities associated with his account (the trading being performed in the ‘street name’ of the broker only exacerbating this problem).

In accordance with the present invention, this problem is addressed by inserting a trusted, independent third party entity into the transaction process, referred to as a depository 3, as shown in FIG. 1. Depository 3 has the job of holding assets for the benefit of the owners. It is not a broker itself, and its job is to be above suspicion and above reproach. The critical restrictions placed upon depository 3 can be outlined as follows: (1) it does not buy, sell or trade financial assets; (2) it has significant insurance again lost or stolen assets (a US-based depository can be backed by the “full faith and credit of the United States”, as an example); and (3) it must be regularly audited by external auditors to assure security of the held assets.

An individual becomes a registered “account owner” with depository 3 through a process described in detail hereinbelow, as does any brokerage firm that wants to do business with the registered account owners. The account owner then transfers his securities to depository 3 (including paper certificates, demand certificates and the like) as well as any cash he wishes to place on account. It is contemplated that this transfer will use standard processes already in place and used to transfer the securities to be “held” by a broker. When the individual desires to initiate a transaction, he communicates with the depository who then, in turn, communicates the transaction information to the broker. There are encryption mechanisms put in place between account owner 1 and depository 3, as well as between broker 2 and depository 3, to maintain security and integrity of the transactions. Checks and balances performed by both depository 3 and broker 2 ensure that account owner 1 is properly positioned to perform the desired transaction, as will be described in detail below. In accordance with the present invention, by using depository 3 as the “holder” of the securities, the individual securities are only released to broker 2 on a transaction-by-transaction basis, as requested by account owner 1. Therefore, should broker 2 go out of business, account owner 1 remains protected since his assets not involved in a sale or purchase at the time of the business failure remain under the control of depository 3.

As shown in FIG. 1, depository 3 includes an account owner database 100, the database including a listing of all of the records of a registered account owner. Each registered account owner is assigned a unique ID number that will be used by depository 3 to query and manipulate the information in account owner database 100. A separate broker database 200 is used to store the identities of the brokers associated with depository 3. A separate memory unit 300 may be used in depository 3 to store the various templates used to create the messages associated with securities transfers, the messages being discussed in detail below. A special-purpose processor 400 included within depository 3 is used to communicate with both account owner 1 and broker 2, where special-purpose processor 400 interacts with memory unit 300, account owner database 100 and broker database 200 to effect the various transactions that will be discussed in detail below.

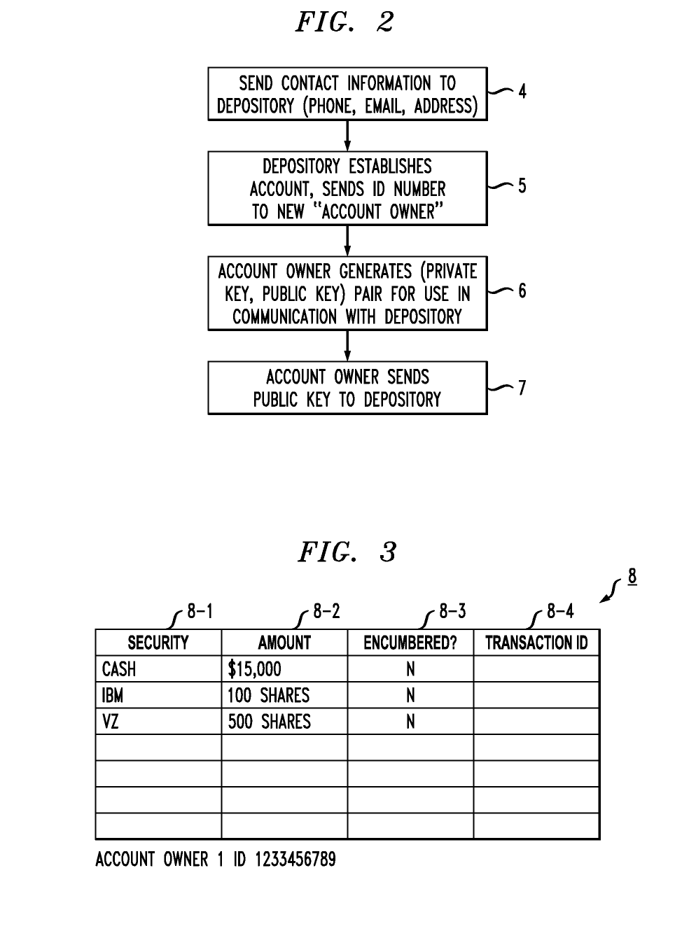

FIG. 2 contains a flowchart of an exemplary process used by an individual to become an account owner 1 that is registered with depository 3. As mentioned above, both individuals and brokers are required to create accounts with the depository. The account created by a broker has additional capabilities such as the ability to transfer securities between customer accounts without limit (as compared to individual accounts, where an ordinary customer can only transfer securities to broker accounts).

As shown, the process of creating a new account starts with an individual sending “contact information” (e.g., mailing address, phone number, email address) to a recognized entity functioning as a depository, at step 4. In return, depository 3 transmits an account number back to the individual (step 5), now defined as an “account owner”. The account owner then generates a (private key, public key) pair (step 6) that will be used as an “authenticity” check for all of the transactions undertaken on his behalf. The public half of the key is then transmitted to depository 3 (step 7). Any well-known key generation technique may be used (RSA, PGP, GPG, or the like), where the length of the key needs to be sufficient to meet the requirement that there is little likelihood that an attacker can discover the private key by examining messages. It is also possible that from time to time the account owner will generate a new key pair, and will then need to send the updated public key to depository 3.

Once the individual has created the (private key, public key) pair and transmitted the public key to depository 3, the individual can begin to transfer assets to the depository and be assured that the assets will be properly associated with his account.

There are at least four different mechanisms that may be used to transfer assets to an owner's account (and this listing may not be exhaustive). First, if the assets are associated with a broker account, they can be transferred using established, conventional techniques. If the securities exist in paper format, the security can be endorsed over to depository 3 and physically delivered to depository 3 (via registered mail, messenger, or another secure service). If depository 3 also accepts “bearer bonds” (or similar instruments), they may need to be personally delivered to a place of business of depository 3. Obviously, cash funds can be sent by check or through any acceptable bank electronic fund transfer method.

In each instance, depository 3 will acknowledge the receipt of the securities—electronically (email, IM), telephonically (voicemail) or on paper (via mail). Indeed, it is expected that depository 3 will have a web-based interface that allows registered account owners to check their holdings. This would be consistent with current methods of doing e-banking and e-brokerage, involving passwords, smart tokens, biometrics, and/or whatever other identification technologies are deemed sufficient to provide privacy and security. Depository 3 thus includes a database of information for each account owner (as well as physically “holding” the securities), where the account owner himself is generally afforded access to his particular account information through a website or other type of computer-based interaction with depository 3.

FIG. 3 illustrates an exemplary record 8 of an account owner's holdings as stored in a database at depository 3. As mentioned above, it is preferred that account owner 1 is able to “view” this information at any time and the configuration as shown in FIG. 3 is well-suited for use as a screenshot for that purpose. In this exemplary embodiment, record 8 is linked with this individual's account number (each customer record thus uniquely associated with a separate record and indexed by account number). Record 8 includes an identification of each held security in column 8-1, the “worth” or dollar amount associated with that security in column 8-2, an identification of its encumbrance in column 8-3 (a security will be flagged as “encumbered” if currently involved in a transaction, as well be discussed in detail below) and a transaction ID will be entered into column 8-4 for those securities involved in an on-going transaction. Obviously, the format of record 8 is exemplary only, and the information associated with a registered account owner may be retained in any other suitable configuration.

Once an account owner has transferred his assets (or a select subset of assets) to depository 3, he is in position to buy, sell, or perform other transactions with these assets. Various ones of the actions that may take place will be described below (the description of each possible transaction not being exhaustive), where it will become obvious that the utilization of depository 3 as an independent intermediary between account owner 1 and broker 2 allows for the account owner 1 to continue to enjoy the benefits of electronic transactions without the worry about his securities being held in ‘street name’ by his broker. Indeed, the intended purpose of the system of the present invention is to utilize depository 3 to lessen the risk for security owners, while allowing them to sell securities as readily as if they were held in street name.

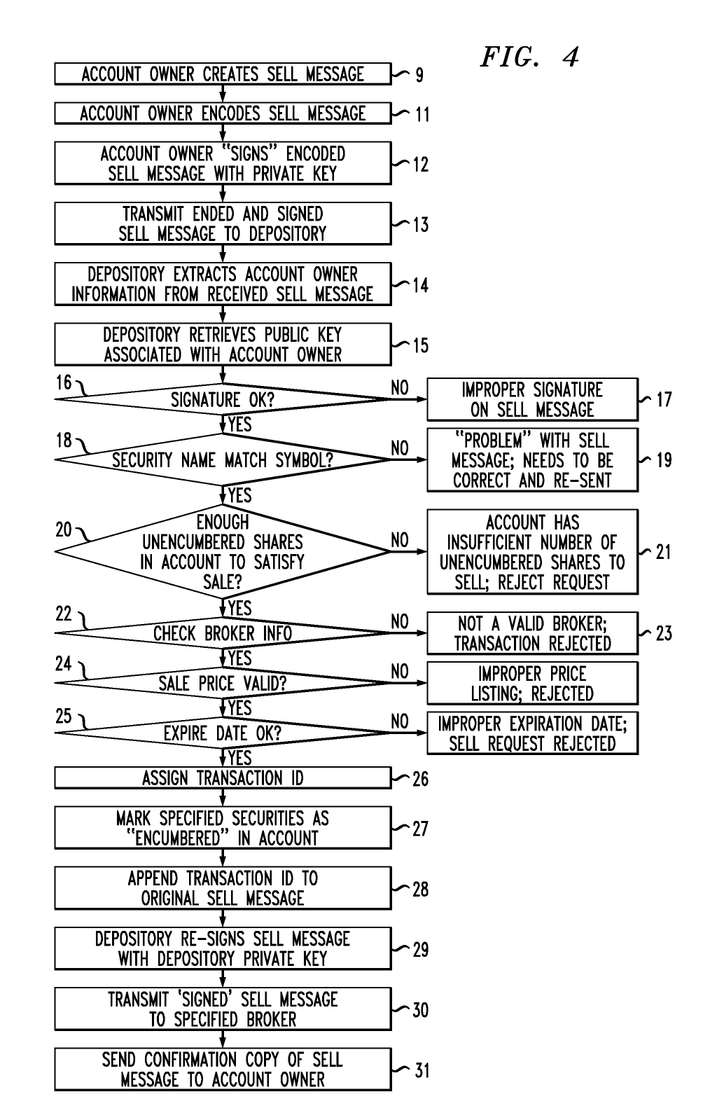

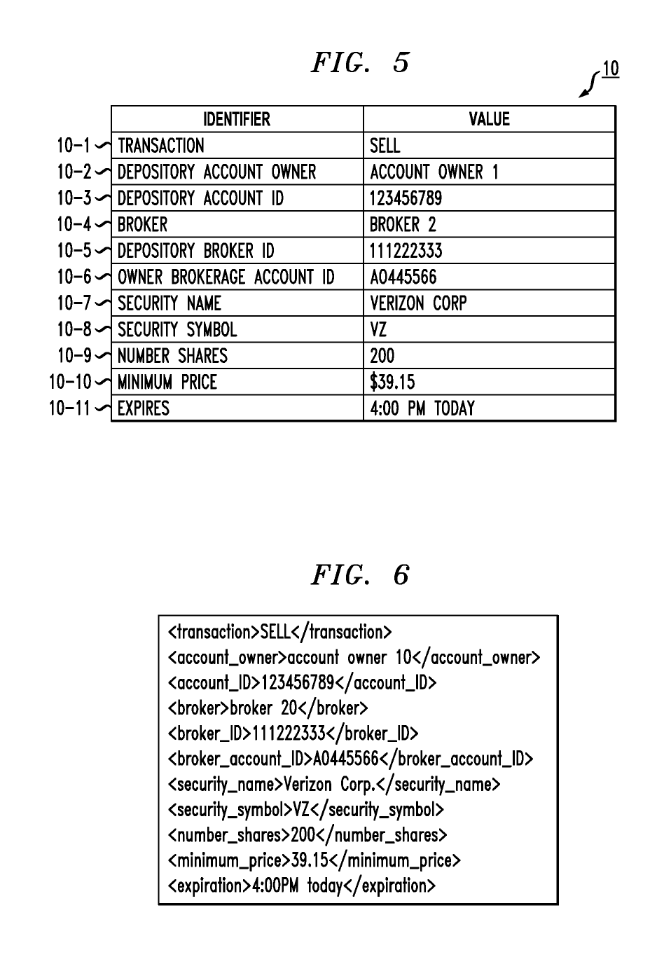

FIG. 4 is a flowchart of the steps involved in account owner 1 initiating a sale of a selected security. Reference will also be made to record 8 as shown in FIG. 3 during the course of describing the process of initiating a sale. Referring to FIG. 4, the process begins with account owner 1 creating a SELL message (step 9). For the purposes of discussion, it is presumed that account owner 1 wishes to sell 200 shares of Verizon at a price above $39.15 (the current price being $39.25). It is also presumed that account owner 1 has previously established a relationship with a broker 2 that has an account with depository 3 (the establishment of this account is presumed to follow the same procedures as conventionally employed, providing the broker with all necessary information to conform with tax and anti-terrorism laws). An exemplary SELL message 10 is shown in FIG. 5 and includes the following fields of information that are populated by account owner 1 in creating the message:
Transaction field 10-1—defines the ‘type’ of transaction the account owner wishes to initiate, in this case the transaction is “SELL”
Depository account owner field 10-2—includes the actual name of account owner 1
Depository account ID field 10-3—account owner 1 must enter his assigned account ID in this field
Broker field 10-4—account owner 1 enters the same of the (registered) broker 2 through whom he desires to perform the transaction. As stated above, account owner 1 must have a pre-existing relationship with broker 2 and broker 2 needs to be registered with depository 3
Depository broker ID field 10-5—presumably, account owner 1 knows and can enter the ID number that depository 3 has associated with broker 2
Owner brokerage Account ID field 10-6—account owner 1 supplies the specific account number that identifies his association with broker 2
Security Name field 10-7—account owner 1 enters the “name” of the security that he desires to sell (in this case, “Verizon”)
Security Symbol field 10-8—account owner 1 also enters the symbol used by the Security for trading on one of the major exchanges (in this case, VZ, as traded on the NYSE)
Number of Shares field 10-9—account owner 1 enters the number of shares he wishes to be sold
Minimum price field 10-10—account owner 1 enters the “minimum price” he is willing to accept for selling his shares
Expiration field 10-11—account owner 1 enters the date and time his “sell” offer will expire

It is to be understood that the specific fields shown in message 10 are exemplary only, and other fields may be included, the order of the fields may be modified and/or combined, as long as depository 3 receives sufficient information to undertake the “sell” process. Indeed, as will become apparent, most of the “message” formats used by account owner 1, broker 2 and depository 3 are based on a similar format, where the “transaction” field is the critical entry used by all the parties to determine the proper sequence of steps to follow.

Referring back to the flowchart of FIG. 4, once all of the fields of SELL message 10 are populated, SELL message 10 is encoded (step 11) in an XML-like ASCII, or Unicode data structure as shown in FIG. 6. The encoded message is then “signed” by the private key created by account owner 1 (step 12). The private key is known only by account owner 1.

Encoded and signed SELL message 10 can be uploaded to depository 3 by a web form, or sent in an email (step 13). It is possible that other levels of encryption/security can be added to the transmitted message (or any of the other messages described below). The web page may be locked with a session key generated by the use of an X.509 certificate of the web site.

When SELL message 10 is received by depository 3, a number of checks are performed to authenticate the message prior to sending it along to the identified broker 2. Firstly, the account holder information is extracted from the signed message (step 14), and the public key or signature verification key for account owner 1 is retrieved (step 15). The digital signature is then checked (step 16) and the message is “rejected” if the signature is incorrect and account owner 1 is notified (step 17) that an improperly signed transfer request has been submitted on his behalf.

Presuming that the signature is correct (which defines the message as “authentic”), the name of the security being sold is then checked (step 18) to see that it corresponds to the supplied trading symbol. If there is a mismatch between the security name and symbol, account owner 1 is notified (step 19) that there is problem with his “sell” message and that he needs to submit a new “sell” request. If the security name and symbol match, then record 8 of account owner 1 is next queried (step 20) to confirm that account owner 1 indeed owns 200 “unencumbered” shares of Verizon. If either account owner 1 owns less than 200 shares, or if the shares he owns are encumbered, a failure message is sent to account owner 1 (step 21), explaining why the “sell” request cannot be accepted. In this particular example, and with reference to record 8 of FIG. 3, it is shown that account owner 1 owns 500 “unencumbered” shares of Verizon, so he is able to proceed with the sale of 200 shares.

At some point in the process, the broker's name is checked against the broker's depository account (step 22) to make sure a valid broker is being requested to perform the sale of securities. Again, if this check fails, the “sell” request is halted (step 23) and account owner 1 is sent a message that the broker name/ID is invalid. The price can also be checked to make sure that it is positive (step 24) and that the expiration date “makes sense” (step 25) (e.g., not a date from the past, or a day of the month that does not exist). Obviously, this series of “checks” can be performed in any order, as long as each of these validation procedures is carried out before continuing with authorizing the “sell” transaction.

Once the set of “checks” is completed and passed, then depository 3 assigns a transaction ID to this event (step 26), stores this transaction ID number in field 8-4 of the portion of account owner record 8 associated with his Verizon holding, and marks the 200 shares of Verizon stock as “encumbered” (step 27). The marking as “encumbered” is to protect broker 2 and prevent account owner 1 from requesting another “sell” involving the same 200 shares of Verizon while this sale is pending. The following table shows the status of all 500 shares of Verizon stock in record 8 of account owner 1:

| SECURITY | AMOUNT | ENCUMBERED? | TRANSACTION ID |
|---|---|---|---|
| VZ | 300 | N | |
| VZ | 200 | Y | 666777888999 |

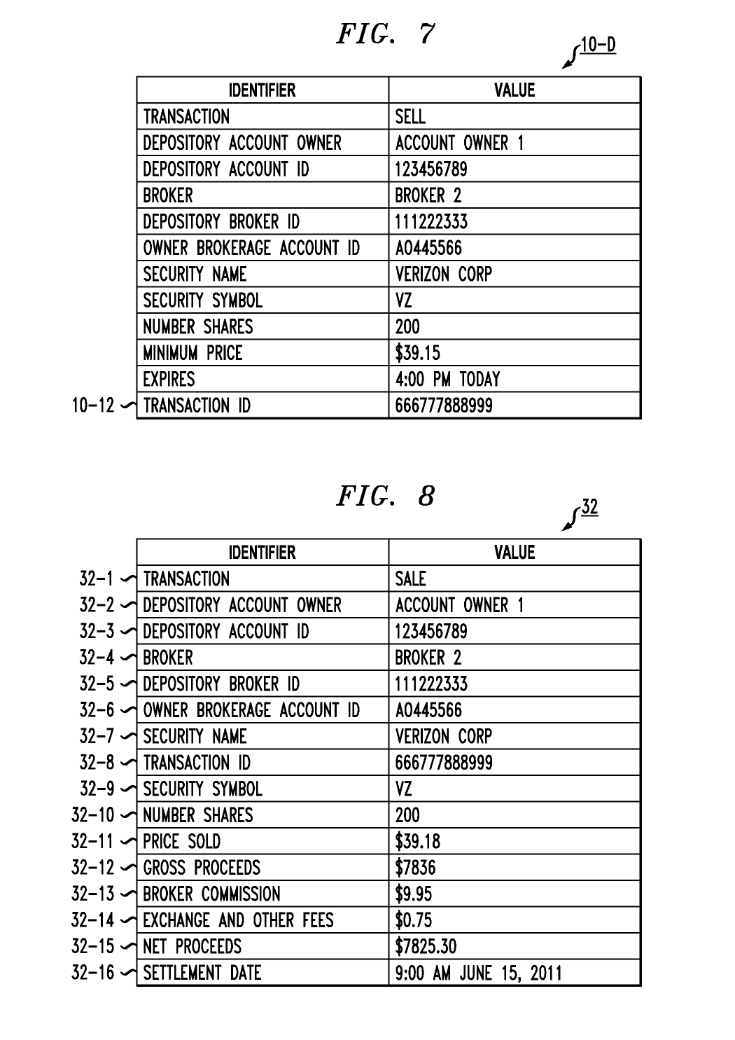

Referring back to the process as outlined in FIG. 4, the transaction ID is next appended to SELL message 10, shown in FIG. 7 as transaction ID field 10-12 (step 28), where the message itself is now defined as SELL message 10-D. SELL message 10-D is then “signed” by depository 3 (step 29) with the private key of its (private key, public key) pair. The signed SELL message 10-D is sent to broker 2 (step 30), with a copy of the message also sent to account owner 1 as a confirmation (step 31). If desired, the messages can be encrypted using the public keys of the broker and account owner before transmission.

Once SELL message 10-D is received by broker 2, there are three possible outcomes to consider. First, broker 2 could offer the shares for sale, and the offer expires without a buyer accepting the offer. This condition would be noticed by depository 3, since no “SALE” message would be received as a response from broker 2 during the defined sale period. In this case, depository 3 transmits a “CANCEL” message to both broker 2 and account owner 1, and the shares are unencumbered. In some cases, it may happen that the market drops so quickly and severely that the “current” price drops below an acceptable level (in this case, perhaps below $30/share). Broker 2 may then issue a “REJECT” reply to depository 3 with respect to the transaction ID and, again, the shares are un-encumbered. Account owner 1 is also notified that broker 2 has “rejected” the opportunity to handle his “sell” request.

Thirdly, broker 2 may find a willing buyer for the 200 shares of Verizon being offered for sale by account owner 1. FIG. 8 is an exemplary SALE message 32 as created by broker 2 in this instance. SALE message 32 includes the following fields of information that are populated by broker 2 in creating the message:
Transaction type field 32-1: broker 2 identifies this transaction as a “SALE”
Depository account owner field 32-2: identified as account owner 1
Depository account ID field 32-3: this is the account number associated with account owner 1
Broker field 32-4: an identification of broker 2 by name
Depository broker ID field 32-5: the ID of broker 2's account with depository 3
Owner brokerage account ID field 32-6: this is the particular account ID of account owner 1 associated with broker 2
Security name field 32-7: broker 2 enters the “name” of the security that was sold, in this case, “Verizon”
Transaction ID field 32-8: broker 2 supplies the transaction ID created by depository 3 for this particular transaction
Security symbol field 32-9: broker 2 also enters the symbol used by the Security for trading on one of the major exchanges (in this case, VZ, as traded on the NYSE)
Number of shares field 32-10: broker 2 enters the number of shares that were sold, in this case, 200 shares
Price sold field 32-11: broker 2 enters the selling price (per share) for the securities that were sold
Gross proceeds field 32-12: broker 2 enters the “gross” amount received for the sale
Broker commission field 32-13: broker 2 enters his commission in this field
Exchange and other fees field 32-14: broker 2 enters miscellaneous fees associated with this transaction
Net proceeds field 32-15: broker 2 enters the amount to be credited to account owner 1
Settlement date field 32-16: broker 2 supplies the date and time associated with the completion of the sale to the buyer

As mentioned above, it is clear that in comparing SELL message 10 to SALE message 32, a number of the fields contain the same information. These similarities will carry over to the discussion of the other types of messages described below.

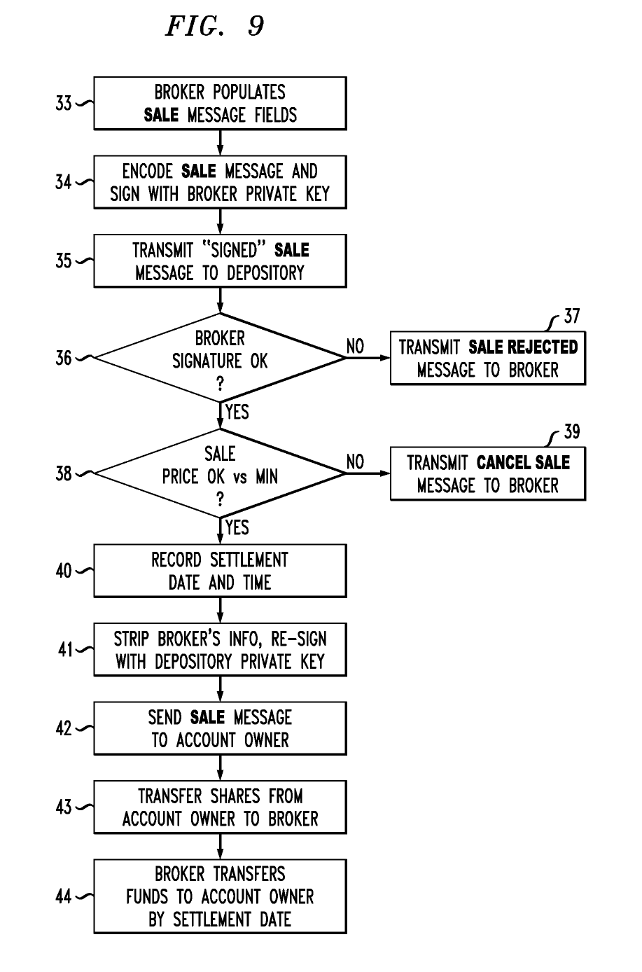

FIG. 9 is a flowchart associated with the completion of the sale process, which begins with broker 2 populating SALE message 32 in the manner shown in FIG. 8 (step 33). SALE message 32 is then encoded in a manner similar to that used with the original “sell” request and signed with the private key of the (private key, public key) pair created by broker 2 (step 34). Once the message is encoded and signed, it is transmitted to depository 3 (step 35). Upon reception, depository 3 first checks the signature of broker 2 (step 36) to determine if the message is authentic. If the signature does not match, an error message is sent to broker 2 (step 37). Otherwise, depository 3 then proceeds to check the sale price (field 32-11 of SALE message 32) against the minimum specified for the transaction (field 10-10 of SELL message 10), noted as step 38. If less than the minimum, depository 3 sends a message to broker 2 to flag a “problem” with the sale (step 39). An alternative is to notify the account owner and broker that the sale is below the minimum specified price and allow some dispute resolution mechanism to kick in.

If the sale price is acceptable (which it is in this specific example, with the sale price of $39.18 being greater than the minimum of $39.15), the settlement date and time is noted by depository 3 (step 40), the broker's signature is removed from SALE message 32 and re-signed with the private key of depository 3, forming SALE message 32-D (step 41). The re-signed message is then sent to account owner 1 (step 42). Alternatively, depository 3 may sign the broker's message with its own private key and transmit the doubly signed message to account owner I. This would assure account owner 1 that depository 3 did not retain any funds implied by the SALE message.

Importantly, upon acceptance of the conditions of SALE message 32, the encumbered shares as identified in record 8 of account owner 1 are then transferred to the depository account of broker 2 (step 43) before the settlement date and the listing of Verizon shares as owned by account owner 1 is updated in his record 8 to appear as shown below:

| SECURITY | AMOUNT | ENCUMBERED? | TRANSACTION ID |
|---|---|---|---|
| VZ | 300 | N | |

Unlike prior art transactions, this is the first instance that broker 2 is in “possession” of the securities. A “transfer” message (as discussed below) is used to perform this function, with the message signed by depository 3 and transmitted to both account owner 1 and broker 2. The process is completed by the transfer of the received funds from broker 2 to the account of account owner 1 (step 44). If the securities were in street name (which is the prior art conventional method), the transfer of the securities from the account owner to the broker would be automatic after the sale. It is desired that such an “automatic” process be retained in the methodology of the present invention. Therefore, depository 3 will send the TRNAFER message to broker 2 to notify broker 2 that the securities are now in his account (i.e. in street name) and the broker can then settle the trade. Account owner 1 may or may not receive a copy of this message.

FIG. 10 illustrates an exemplary TRANSFER message 45 that is used by depository 3 to record the sale of securities by account owner 1 (in this case, 200 shares of Verizon stock) through broker 2. As with the other described messages, various other formats may be used, as long as the necessary information is passed from account owner 1 to depository 3. In the exemplary embodiment of FIG. 10, TRANSFER message 45 includes the following fields:
Transaction type field 45-1: broker 2 identifies this transaction as a “TRANSFER”
Depository account owner field 45-2: identified as account owner 1
Depository account ID field 45-3: this is the account number associated with account owner 1
Broker field 45-4: an identification of broker 2 by name
Depository broker ID field 45-5: the ID of broker 2's account with depository 3
Owner brokerage account ID field 45-6: this is the particular account ID of account owner 1 associated with broker 2
Security name field 45-7: broker 2 enters the “name” of the security that was sold, in this case, “Verizon”
Security symbol field 45-8: broker 2 also enters the symbol used by the Security for trading on one of the major exchanges (in this case, VZ, as traded on the NYSE)
Number of shares field 45-9: broker 2 enters the number of shares that were sold and are now being transferred to the account of broker 2 (i.e., 200 shares)
Transfer date: broker 2 enters the date upon which the transfer to his account is to occur
Transfer time: broker 2 enters the “time” associated with the transfer

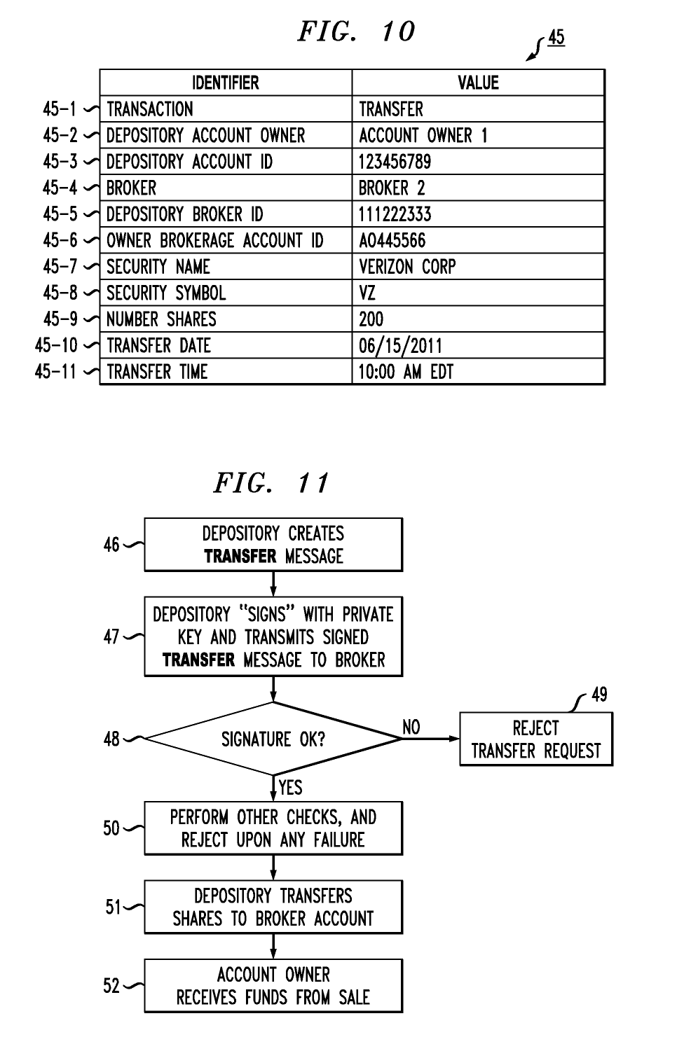

FIG. 11 is a flowchart explaining the particulars of the transfer process used to move the “sold” securities from account owner 1 to broker 2. The process begins with the creation of a TRANFER message 45 by depository 3 (step 46). TRANSFER message 45 is then signed by depository 3 and transmitted to broker 2 (step 47). Upon receipt, broker 2 retrieves the depository information and accesses its public key to use in verifying the signature (step 48). If the signatures do not “match”, the transfer is rejected, and a ‘failure’ message is sent to depository 3 (step 49). Otherwise, broker 2 continues with the various “checks” as described above (step 50). If all of these checks are passed, then depository 3 will act to transfer the identified shares from account owner 1 to broker 2 (step 51). After receipt of the shares, broker 2 may then go forward with the sale and, ultimately, deposit the received funds with account owner 1 (step 52) by the settlement date.

It is important to note that should broker 2 not transfer the funds associated with this transaction by the settlement date, a commercial dispute with account owner 1 will result. In one case, it is possible that depository 3 will suspend broker 2 from being involved in any further transactions until this matter is resolved. Alternatively, depository 3 may allow broker 2 to continue with other transactions until a threshold number of “unresolved disputes” has been reached, where at this time broker 2 will be suspended.

Regarding the purchase of assets, it is obvious that conventional purchases directly between broker 2 and account owner 1 may still take place, with account owner 1 then “transferring” the purchased assets to his account with depository 3, using a similar process as that outlined above.

Alternatively, it is also possible to invoke the use of depository 3 to effectuate the purchase of securities on behalf of account owner 1. This procedure may be used by a particular broker 2 who does not “trust” that account owner 1 has sufficient funds to pay for a transaction, and would rather use depository 3 as an intermediary to ensure that the funds are in place to cover the purchase. In this situation, broker 2 would instruct account owner 1 to proceed with the transaction via depository 3. FIG. 12 illustrates an exemplary BUY message 55 that may be populated by account owner 1 and transmitted to depository 3 to initiate this process. In this example, account owner 1 wishes to purchase 400 shares of Cisco at a maximum price of $25/share, and BUY message 55 includes the following fields:
Transaction field 55-1: account owner 1 enters the “buy” command into this field
Depository account owner field 55-2: identified as account owner 1
Depository account ID field 55-3: this is the account number associated with account owner 1
Broker field 55-4: an identification of broker 2 by name
Depository broker ID field 55-5: the ID of broker 2's account with depository 3
Owner brokerage account ID field 55-6: this is the particular account ID of account owner 1 associated with broker 2
Security name field 55-7: account owner 1 enters the “name” of the security that he wishes to purchase, in this example, Cisco Corp.
Security symbol field 55-8: account owner 1 also enters the symbol used by the Security for trading on one of the major exchanges (in this case, CSCO, as traded on the NYSE)
Number of shares field 55-9: account owner 1 enters the number of shares that he wishes to purchase (in this example, 400 shares)
Maximum price field 55-10: account owner 1 enters the maximum price (per share) he is willing to pay for Cisco shares in this transaction (in this case, $25)
Expires field 55-11: account owner 1 enters the time/day that his offer to buy will expire
Maximum commission field 55-12: account owner 1 enters the maximum commission he is willing to pay broker 2 for completing this purchase on his behalf

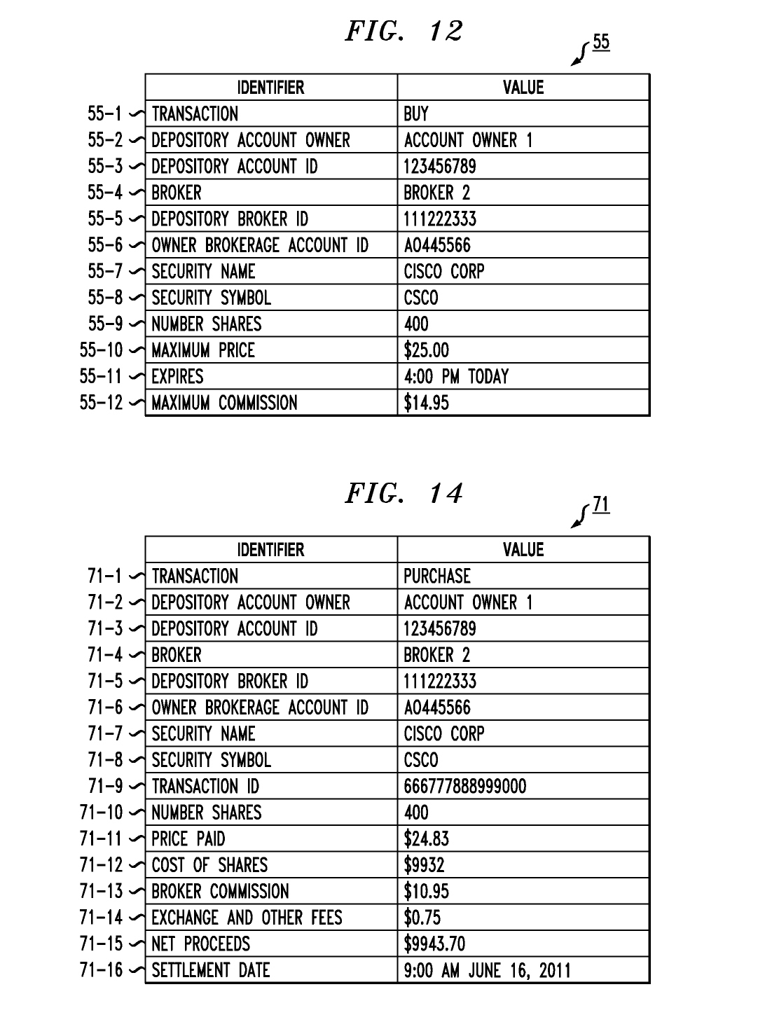

An exemplary sequence of steps that are executed during the “buy” process are shown in the flowchart of FIG. 13. As with the “sell” process discussed above, the “buy” process includes a series of initial “checks” that are performed by depository 3 to authenticate and validate the request to purchase securities. As shown, the process begins with account owner 1 creating BUY message 55 in the form shown in FIG. 12 (step 56). BUY message 55 is thereafter encoded and “signed” by account owner 1 with the private key of the (private key, public key) pair he has created for use between himself and depository 3 (step 57). Signed BUY message 55 is then transmitted to depository 3 (step 58), as either a web page entry or associated with an email, or in any other acceptable electronic format.

Upon receipt, a number of checks are performed (as with the various other transactions involving depository 3) to authenticate the message prior to sending it along to the identified broker 2. Firstly, the account holder information is extracted from the signed message (step 59), and the public key or signature verification key for account owner 1 is retrieved (step 60). The digital signature is then checked (step 61) and the message is “rejected” if the signature is incorrect and account owner 1 is notified (step 62) that an improperly signed “buy” request has been submitted on his behalf.

Presuming that the signature is correct (which defines the message as “authentic”), the name of the security to be purchased is then checked (step 63) to see that it corresponds to the supplied trading symbol. If there is a mismatch between the security name and symbol, account owner I is notified (step 64) that there is problem with the content of BUY message 55 and that he needs to submit a new “buy” request. The verification may include “checks” of the broker name and account ID, in the same manner as discussed above, even though these specific steps are not outlined in the flowchart of FIG. 13.

Record 8 of account owner 1 is next queried (step 65) to retrieve the “cash” balance on account. A check is then made to see if the cash balance is sufficient to cover the cost of the transaction (step 66), where in this example account owner needs to have $10,014.95 available to cover the purchase at his maximum acceptable price. If there are insufficient funds for this transaction, account owner 1 is sent a notification (step 67) that he has insufficient funds for this transaction, and the process is halted. In this case, record 8 of account owner 1, as shown in FIG. 3, indicates that account owner 1 has a cash balance of $15,000, which is more than enough cash to cover this purchase. Depository 3 then proceeds to “encumber” $10,014.95 of the balance and assigns a transaction ID to this event (step 68). It is possible that the depository encumbers only the funds for the purchase and not the funds for the commission.

The following table illustrates the modifications made by depository 3 to the “cash” entry in record 8:

| SECURITY | AMOUNT | ENCUMBERED? | TRANSACTION ID |
|---|---|---|---|
| CASH | $10,014.95 | Y | 666777888999000 |
| CASH | $4985.05 | N | |

showing that it has now been split into two separate entries, a first entry of the amount of cash necessary for this transaction, where it is flagged as “encumbered” and has an assigned transaction ID. The remaining balance of the cash in the account is shown on a separate line since this cash is still “available” for use in other transactions. It is important to delineate that the encumbrance only applies to the specific amount necessary for the purchase of 400 shares of Cisco, allowing for account owner 1 to submit (perhaps) another “buy” message for a different security.

At this point, depository 3 modifies “buy” message 80 to include the transaction ID and then signs modified BUY message 55-D (step 69) and forwards it to broker 2 (step 70). As an option, this modified “buy” message 55-D may also be sent to account owner 1 to keep him apprised of the status of the purchase transaction.

When broker 2 receives BUY message 55-D from depository 3, he will proceed with the same verification steps as outlined above for a SALE message. That is, he will make sure that the signature of depository is valid and that the ID information associated with account owner 1 makes sense. As with the “sell” process discussed above, there are three different outcomes of a “buy” request: (1) the shares are purchased for account owner 1 (described below as the “PURCHASE” process); (2) the time period expires without a purchase (with broker 2 sending an “EXPIRE” message to depository 3); or (3) the broker “rejects” the order (and sends a “REJECT” message to depository 3).

Presuming that broker 2 is able to purchase the shares on behalf of account owner 1, FIG. 14 illustrates an exemplary PURCHASE message 71 that is created for transmission back to depository 3. PURCHASE message 71 includes the following fields of information that are populated by broker 2 in creating the message:
Transaction type field 71-1: broker 2 identifies this transaction as a “PURCHASE”
Depository account owner field 71-2: identified as account owner 1
Depository account ID field 71-3: this is the account number associated with account owner 1
Broker field 71-4: an identification of broker 2 by name
Depository broker ID field 71-5: the ID of broker 2's account with depository 3
Owner brokerage account ID field 71-6: this is the particular account ID of account owner 1 associated with broker 2
Security name field 71-7: broker 2 enters the “name” of the security that was purchased, in this case “Cisco Corp.”
Security symbol field 71-8: broker 2 also enters the symbol used by the Security for trading on one of the major exchanges (in this case, CSCO, as traded on the NASDAQ)
Transaction ID field 71-9: the transaction ID that depository 3 has assigned to this particular event
Number of shares field 71-10: broker 2 enters the number of shares that were purchased (in this example, 400 shares)
Price paid field 71-11: broker 2 enters the purchase price (per share) for the securities that were purchased ($24.83)
Cost of shares field 71-12: broker 2 enters the price paid for the total number of shares that were purchased
Broker commission field 71-13: broker 2 enters his commission in this field
Exchange and other fees field 71-14: broker 2 enters miscellaneous fees associated with this transaction
Net proceeds field 71-15: broker 2 enters the amount to be paid to the seller by account owner 1
Settlement date field 71-16: broker 2 supplies the date and time associated with the completion of the purchase by the buyer

When depository 3 receives PURCHASE message 71, it will transfer the net proceeds amount (out of the ‘encumbered’ cash associated with account owner 1) to broker 2 by the settlement date. If there is remaining cash in this encumbered line (in this case, a remaining $68), the ‘encumbered flag’ will be removed to allow this remaining cash to revert to be available for use. While the specific flowchart for this series of steps as performed by depository 3 are not shown, it is presumed that they follow a similar course as those outlined above upon receipt of a “sell” message (that is, broker 2 is authenticated and the message itself is checked for verification).

Should the “buy” order expire without being executed, the processing by depository 3 is exactly the same as when a “sell” order expires without being executed, in this case with the “encumbered” funds then being un-encumbered at the expiration of the time period. Similarly, when a “reject” message is received from broker 2, the funds are un-encumbered and account owner 1 is notified.

As opposed to the particular “buy” order discussed above, it is also possible for account owner 1 to request that securities be purchased at “market” value. For example, account owner 1 may request broker 2 to purchase 400 shares of Cisco at the best available price. In this example, depository 3 does not know the amount of cash to “encumber” to ensure that the transaction will proceed as desired.

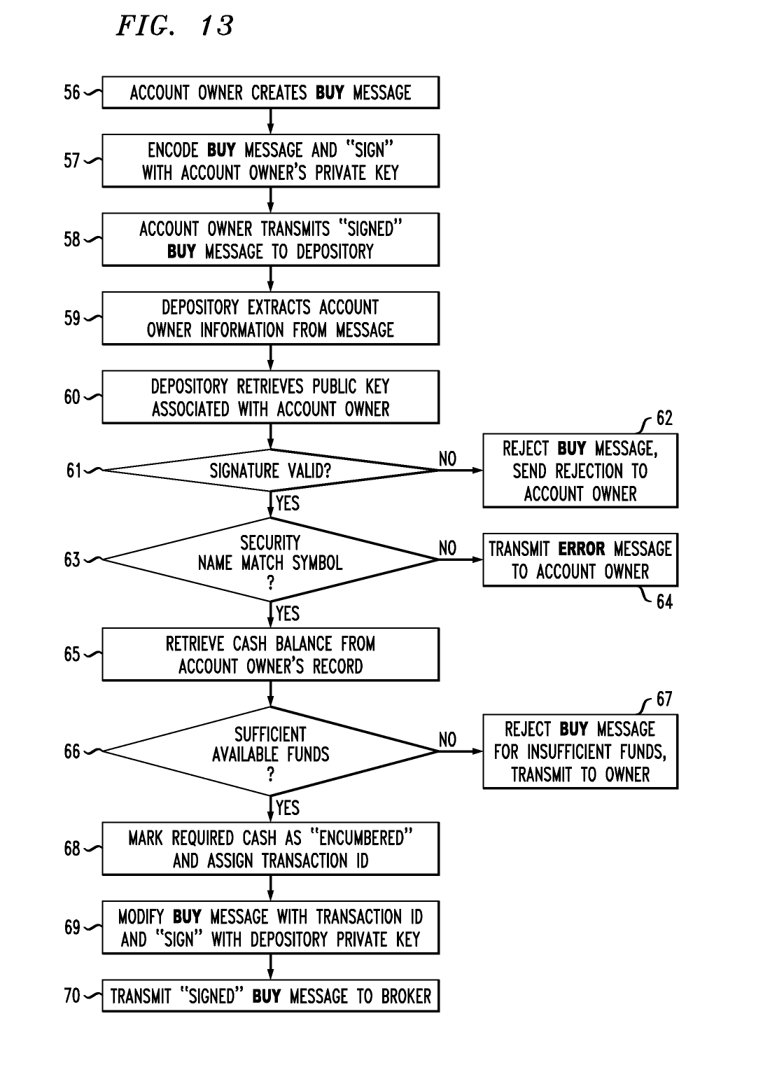

An exemplary MARKET BUY message 72 is shown in FIG. 15. Again, this message is created by account owner 1 to initiate the “market buy” process. In comparison to BUY message 55 of FIG. 12, the “maximum price field” 72-10 is populated by the term “MARKET”, which will trigger depository 3 to proceed along a slightly different path in following through on this transaction. An additional “available cash” field 72-11 is included in MARKET BUY message 72 as shown in FIG. 15. In this case, the entire cash balance of account owner 1 held by depository 3 may be shown on this line (optionally, for a client with an extremely large amount of cash on deposit, broker 2 and account owner 1 may have agreed in advance to waive encumbering cash and the field will contain the phrase WAIVED. Should broker 2 not have agreed to waive the requirement, the order will be REJECTED with an explanation that cash must be encumbered. Presuming that the entire cash balance is listed on the market buy message, depository 3 will encumber the entire cash fund and transmit the order to broker 2 in a manner similar to that outlined above. Since market orders are rapidly executed, once the reply PURCHASE message is received by depository 3, it will transfer the cash necessary for the purchase to broker 2 and un-encumber the remaining cash balance.

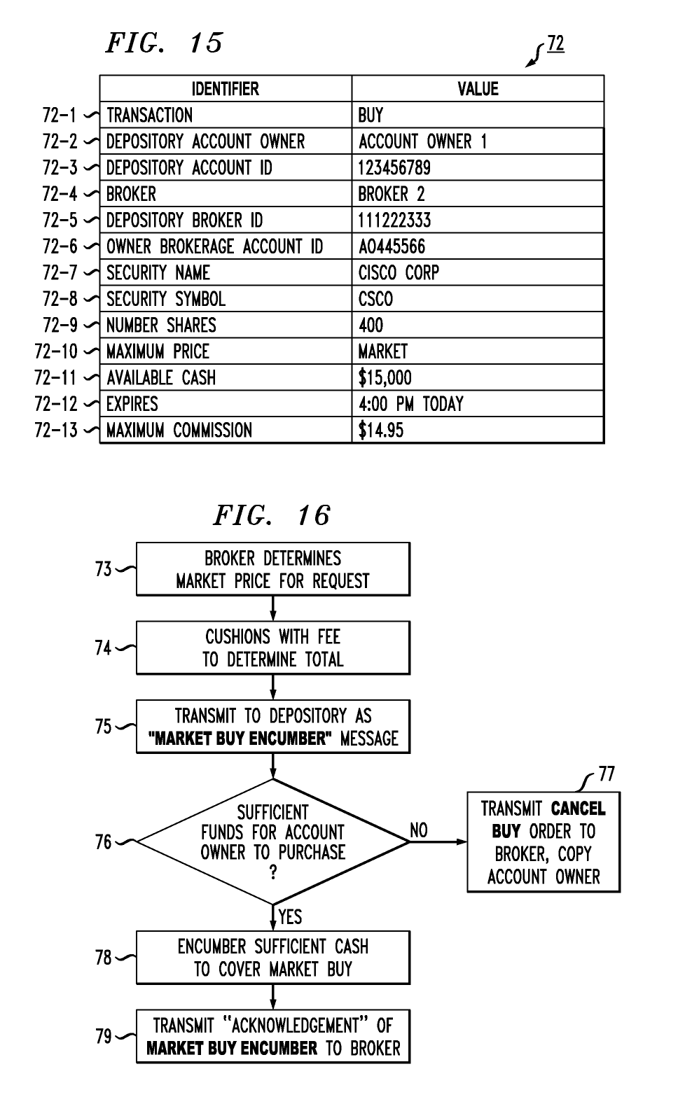

There may be instances (or certain account owners) where it is not prudent to “advertise” an entire cash balance on a market buy message. The system of the present invention can handle this type of market buy in a slightly different process. The steps for this process are shown in flowchart of FIG. 16. Upon receiving MARKET BUY message 72 from depository 3 (and after performing the requisite checks and verifications), broker 2 first determines the current asking price for the stock being purchased (step 73), adding a “cushion” to this price, as well as broker's fees and other expenses (step 74). The total cost is then sent back to depository 3 as a “MARKET BUY ENCUMBER” message (step 75). Depository 3 then acts to determine if there is sufficient cash in the fund of account owner 1 (step 76), and either sends a “STOP PURCHASE” message to broker 2 if there are insufficient funds (step 77), or proceeds to encumber the requested dollar amount (step 78) and send an ACKNOWLEDGEMENT of the encumbrance to broker 2 (step 79). When the purchase is consummated, the necessary funds will be transferred to broker 2 and any remaining funds un-encumbered.

In rare cases the market will be changing so rapidly that the original cash estimate will not be sufficient to cover the purchase. In this case, depository 3 sends the cash on hand to broker 2, and then notifies both broker 2 and account owner 1 of the shortfall, allowing them to settle the matter between themselves.

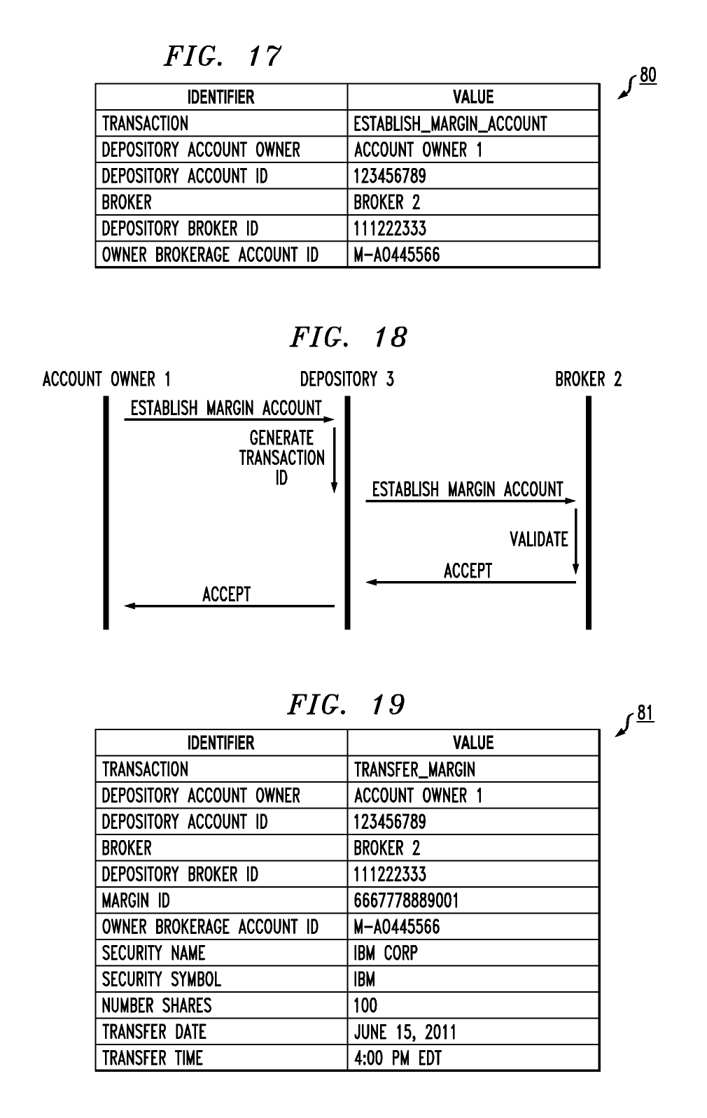

Traditionally, brokers offer both cash accounts and margin accounts. Up to this point, the discussion of the utilization of depository 3 has focused on the former. However, it is also possible to utilize depository 3 in accordance with the present invention as an intermediary with margin accounts, again performing the function of holding the assets for the account owner and releasing permissions to the broker on a transaction-by-transaction basis. An exemplary request to create a margin account is shown as a “create margin” message 80 in FIG. 17. The fields are populated by account owner 1, and the indication in the transaction field of “establish margin account” will trigger the series of events as outlined in the diagram of FIG. 18. As shown, the initial margin account is established between account owner 1 and depository 3, where depository 3 attaches a transaction ID to this request and then forwards it to broker 2. Broker 2 validates that account owner 1 has an existing account relationship with him, and sends an ‘accept’ message in reply to depository 3, where this ‘accept’ message is then relayed to account owner 1 (or directly sent from broker 2 to account owner 1). Inasmuch as account owner 1 may have established ‘traditional’ margin accounts with different brokers, each of these margin accounts would need to be separately created and managed by depository 3.

Once the margin account has been established, account owner 1 can transfer securities from his ‘basic’ cash account to his newly-established margin account, using the “transfer” mechanism discussed above. An exemplary “transfer to margin” request message 81 is shown in FIG. 19. As with every other message discussed above, the “transfer to margin” message is signed by the private key of account owner 1 and thereafter ‘checked’ by depository 3 before beginning the specific transfer of any asset. Once verified, the transfer is performed and the transferred security is marked as “encumbered” in the cash account. Once established, account owner 1 can use the assets in the margin account as, for example, collateral for loans by broker 2, as ‘margin’ for the sale of calls or other derivatives, or any other possible margin account use.

There are various uses for a margin account, which are not described in detail, but in each instance will invoke the use of the depository as an intermediary between the margin account owner and the broker. Acquiring a loan against the securities in a margin account is one example.

There is also the current practice that securities held in a margin account can be loaned to other clients of the broker for the purposes of a short sale. This loan is usually without the knowledge of the account holder, and does not appear as an entry on his brokerage statements. The use of a depository in accordance with the present invention is considered to clarify this process. For example, presume an account owner 1-A wishes to sell 200 shares of JP Morgan short. Account owner 1-A is a client of broker 2. Account owner 1-B is also a client of broker 2 and has 500 shares of JP Morgan in his margin account with depository 3 (account owner 1-A is also a registered account owner with depository 3). Previously, account owner 1-B has entered into an agreement with both broker 2 and depository 3 that allows for the borrowing of his securities for short sales.

In this situation, therefore, broker 2 can invoke the loan process by creating a “BORROW SECURITIES” message 82 as shown in FIG. 20. As with all other transactions, account owner 1-B will be notified. It may also turn out that account owner 1-B wishes to know the actual buyer (should broker 2 go into bankruptcy). By virtue of lending securities to only other registered account owners with depository 3, depository 3 will have that information and can provide the extra degree of assurance to account owner 1-B.

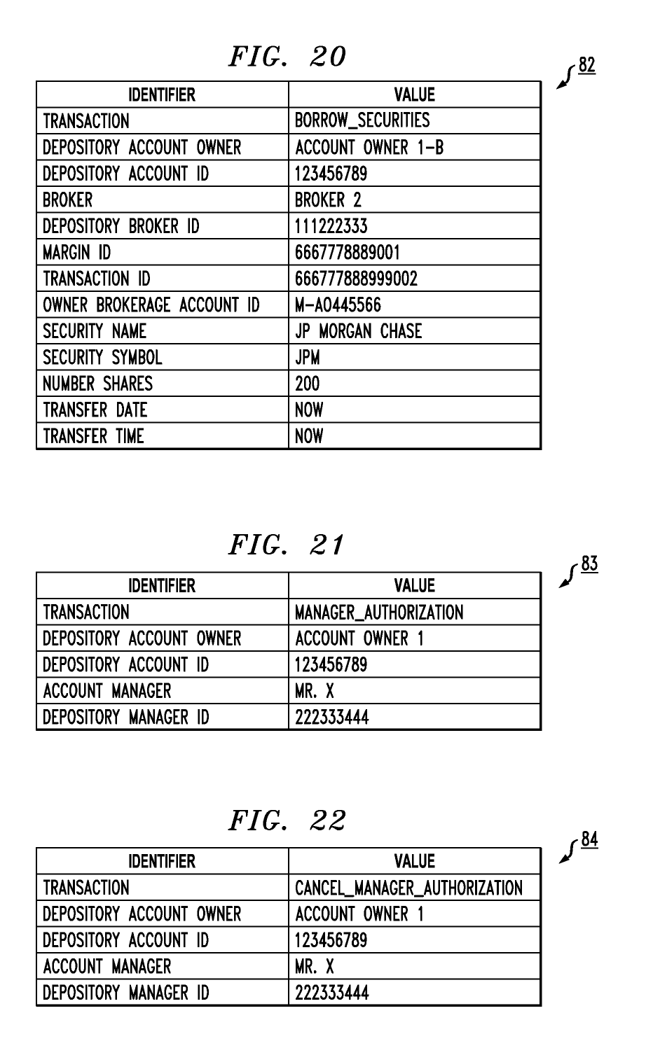

Additionally, it is possible to modify the various transaction flows as outlined above (sell, buy, loan, etc.) to allow account owner I to enlist the services of a professional account manager. In order to effectuate this situation, account owner 1 proceeds to authorize another person (or entity) to issue BUY, SELL or other orders on his behalf. FIG. 21 illustrates an exemplary MANAGER AUTHORIZATION message 83 that may be created by account owner 1 and sent to depository 3 to allow for this authorization to be recognized as “authentic” by depository 3.

The presumptions made in this case are that the individual acting as the account manager is also registered with depository 3 (and has his own ID number) and in order to act in the role as an account manager may have had to provide certain license documentation to depository 3. There can only be one “active” account manager created for an individual account, and that account manager cannot transfer securities to any other account for which he may also be acting as an account manager. Advantageously, this function serves as a protection against “Ponzi schemes”.

Even with the use of an account manager, the best practice remains to have the account owner himself “copied” on all of the transactions that pass through depository 3. The account manager may worry about having his trading strategies copied so he may require that there be a delay (for example 24 hours or 48 hours between making any trades and the depository 3 notifying the account owner 1.) And, obviously, the account owner can rescind the permissions of an account manager at any time. FIG. 22 illustrates an exemplary CANCEL MANAGER AUTHORIZATION message 84 that may be used by an account owner in this instance.

There are various other securities trading activities that may involve the use of a depository as described above, and the details of these activities (including the various margin activities that are briefly mentioned) are not described herein, since they following the standard course of trading as is known in the industry.

The purpose of utilizing an intermediary in the form of a depository in any of these transactions is to protect the account owner. For example, in the standard method of operating the business today, if a broker goes out of business for some reasons, the securities held by the broker will become ensnared in the legal proceedings. By using a depository as described above in accordance with the present invention, the account owner is “shielded” from the business practices of the broker, since the broker only accesses his securities on a transactional basis. The depository holds them on behalf of the account owner and, therefore, the securities are not “associated with” the broker. There is a clear audit trail that will be maintained by the depository that will facilitate any investigation into ownership issues of specific securities. Also, the stability of the depository will add a level of comfort to the account owner, who does not need to worry about the “life expectancy” of his broker.

In summary the utilization of the depository in accordance with the present invention allows for securities owners to trade stocks, bonds, futures and other securities as if they were held in street name, without exposing themselves to the financial condition of the specific broker with home the security owner trades. The utilization of computer-based communications and (private key, public key) pairs enables the transactions to be securely and quickly completed, providing a mechanism as easy for use as the current street name trading practice.

What is claimed is:

1. A system for trading securities utilizing a broker on behalf of an owner of securities, the system including
a depository disposed as an intermediary between the owner of securities and the broker, the depository holding securities associated with the owner and transferring securities to the broker only upon completion of a transaction, the depository comprising
a first database of account owner information, including a separate record for each account owner and each record including information identifying an account owner by name and identification number and including a listing of all securities associated with the account owner and held by the depository, the worth of each security, an identification of encumbrance for each security and a transaction ID number of a current security is associated with an on-going transaction;
a second database of broker information, including a separate record for each broker and including information identifying each broker by name and an identification number;
a memory for storing templates of each message type utilized by an account owner or a broker to effectuate a transaction; and
a special-purpose processor for communicating with the first database, the second database and the memory to transmit and receive instructions from the account owner and also to transmit and receive instructions from the broker to effectuate a transfer of securities, without requiring direct communication or transfer of securities between the account owner and the broker.

2. The system as defined in claim 1 wherein the system further comprises an additional database component for storing margin accounts associated with an account owner.

3. The system as defined in claim 1 wherein the templates stored in the memory include a BUY message template, a SELL message template and a TRANFER message template for use by the account owner.

4. The system as defined in claim 1 wherein the templates stored in the memory include a SALE message template and a PURCHASE message template for use by the broker.

5. The system as defined in claim 4 wherein the templates stored in the memory further include an EXPIRE message template and a REJECT message template for use by the broker.

6. A method of initiating the transfer securities through an independent intermediary defined as a depository on behalf of an owner of securities, the method including the steps of:
creating a separate registration for the owner of securities;
transferring securities from the account owner to the depository such that the depository is in physical possession of the securities;
establishing, for each registered owner, a separate account record in an account owner database including an account owner ID and listing a plurality of securities transferred to the depository and held by the depository on behalf of the registered account owner;
receiving, at the depository, a transaction message from the account owner;
authenticating the transaction message at the depository and sending an error message to the account owner if the command cannot be authenticated, otherwise;
retrieving the account owner record and determining if the transaction message can be processed based upon the record information and sending a rejection message to the account owner if the transaction cannot be handled, otherwise;
affirming the transaction message at the depository and transmitting the affirmed transaction message to the broker for action.

7. The method as defined in claim 6 wherein the transaction message comprises a SELL securities message.

8. The method as defined in claim 6 wherein the transaction message comprises a BUY securities message.

9. The method as defined in claim 6 wherein the method further comprises the step of the account owner creating a (private key, public key) pair for use in transmitting messages to the depository, the account owner signing each transaction message with the private key and the depository checking the public key upon receipt of each transaction to perform the authentication.

10. The method as defined in claim 6 wherein the depository creates a (private key, public key) pair for using in transmitting messages to the broker, wherein the step of affirming a transaction message comprises the act of the depository signing the transaction message with the created private key.

11. The method as defined in claim 6, wherein the method further comprises the steps of:
authenticating a received transaction message at a broker;
performing the transaction as required in the message;
creating a transaction confirmation message;
transmitting a transaction confirmation message from the broker to the depository;
authenticating the transaction confirmation message at the depository and sending an error message to the broker if the message cannot be authenticated, otherwise;
determining the validity of the contents of the transaction confirmation message and sending a rejection message to the broker if the terms of the transaction confirmation message are in conflict with the original transaction message or contents of the account owner record, otherwise;
performing the security transfer required to effectuate the requested transaction; and
notifying the account owner upon completion of the transaction.
